(19) United States
(12) Patent Application Publication
(10) Pub. No.: US 2022/0034089 A1
(43) Pub. Date: Feb. 3, 2022

(54) PET FOAM STRUCTURAL INSULATED PANEL FOR USE IN RESIDENTIAL CONSTRUCTION AND CONSTRUCTION METHOD ASSOCIATED THEREWITH

(71) Applicant: JD COMPOSITES INC., Meteghan, Nova Scotia (CA)

(72) Inventors: Joel GERMAN, Meteghan Centre, Nova Scotia (CA); David SAULNIER, Meteghan, Nova Scotia (CA)

(21) Appl. No.: 17/297,692

(22) PCT Filed: Dec. 2, 2019
(86) PCT No.: PCT/CA2019/000162

§ 371 Date: May 27, 2021

(30) Foreign Application Priority Data
Dec. 5, 2018 (CA) 3026529

(51) Int. Cl. E04C 2/24; E04C 2/284; B32B 7/12; B32B 5/18; B32B 5/24

(52) U.S. Cl. CPC E04C 2/243; E04C 2/246; E04C 2/284; B32B 7/12; B32B 5/18; B32B 5/245; B32B 2419/00; B32B 2250/40; B32B 2260/046; B32B 2262/101; B32B 2266/0264; B32B 2307/3065; B32B 2250/03

(57) ABSTRACT

A structural insulated panel is provided. The structural insulated panel comprises a substantially flat PET foam core having a predetermined length, width, and thickness. At least a fiberglass layer is disposed on each of a first and a second surface of the PET foam core. At least a groove is disposed in the PET foam core. The at least a groove is disposed in proximity to an edge of the PET foam core and is adapted for accommodating a joining element therein.

### FIELD OF THE INVENTION

The present invention relates to structural insulated panels, and more particularly to a structural insulated panel made of PET foam for use in residential construction and a construction method associated therewith.

### BACKGROUND OF THE INVENTION

In present day residential construction prefabricated panels made of two sheets of plywood or Oriented Strand Board (OSB) with rigid foam insulation between the boards are more and more used to construct walls, floors, and roofs of buildings. These prefabricated panels, called ‘Structural Insulated Panels’ (SIP) may be fabricated at a manufacturing plant and shipped to a construction site. The use of SIPs substantially reduces onsite construction time while enabling a higher level of precision to the overall building assembly. The SIPs are stronger and provide substantially better thermal insulation than conventional timber frame or masonry construction.

However, SIP construction also has thermal insulation problems caused by thermal breaks occurring where adjacent panels are connected. Furthermore, conventional SIPs can be susceptible to insect infestation, wood decay from excessive trapped moisture, mold, and/or mildew.

With increased frequency of the occurrence of adverse weather events associated with high—and further increasing—wind speeds, the need arises to construct buildings that can withstand such higher ‘hurricane force’ windspeeds, in particular, in coastal areas.

Over the past decades, use of PolyEthylene Terephthalate (PET) for packaging, and particularly, for producing bottles has created an increasing environmental problem associated with the disposal or re-use of the increasing amount of waste PET material. One method for recycling the waste PET material is the production of PET granulate therefrom and using this granulate for producing PET foam products such as PET foam panels.

It is desirable to provide a SIP that is substantially impervious to water, insect infestation, and decay.

It is also desirable to provide a SIP and construction method associated therewith that provides improved thermal insulation by substantially preventing thermal breaks between adjacent panels.

It is also desirable to provide a SIP and construction method associated therewith that increases the strength of a building for resisting higher windspeeds.

It is also desirable to provide a SIP using PET foam made from recycled waste PET material.

### SUMMARY OF THE INVENTION

Accordingly, one object of the present invention is to provide a SIP that is substantially impervious to water, insect infestation, and decay.

Another object of the present invention is to provide a SIP and construction method associated therewith that provides improved thermal insulation by substantially preventing thermal breaks between adjacent panels.

Another object of the present invention is to provide a SIP and construction method associated therewith that increases the strength of a building for resisting higher windspeeds.

Another object of the present invention is to provide a SIP using PET foam made from recycled waste PET material.

According to one aspect of the present invention, there is provided a structural insulated panel. The structural insulated panel comprises a substantially flat PET foam core having a predetermined length, width, and thickness. At least a fiberglass layer is disposed on each of a first and a second surface of the PET foam core. At least a groove is disposed in the PET foam core. The at least a groove is disposed in proximity to an edge of the PET foam core and is adapted for accommodating a joining element therein.

According to the aspect of the present invention, there is provided a structural element. The structural element comprises an elongated substantially flat PET foam core having a predetermined length, width, and thickness. At least a fiberglass layer is disposed at least on each of a first and a second surface of the PET foam core and a surface connecting the same.

According to the aspect of the present invention, there is provided a structural element. The structural element comprises an elongated substantially flat PET foam core having a predetermined length, width, and thickness. At least a fiberglass layer is disposed at least on each of a first and a second surface of the PET foam core and a surface connecting the same. The structural element is connected to a respective second structural element using an adhesive disposed between a second surface of the structural element facing a respective first surface of the second structural element.

According to the aspect of the present invention, there is provided a structural insulated panel. The structural insulated panel comprises a substantially flat PET foam core having a predetermined length, width, and thickness. At least a fiberglass layer is disposed on each of a first and a second surface of the PET foam core such that the at least a fiberglass layer is recessed a predetermined distance from at least an edge of the PET foam core.

According to the aspect of the present invention, there is provided a structural insulated panel. The structural insulated panel comprises a substantially flat PET foam core having a predetermined length, width, and thickness. At least a fiberglass layer is disposed on each of a first and a second surface of the PET foam core such that the at least a fiberglass layer is recessed a predetermined distance from at least an edge of the PET foam core. A first fiberglass layer of the at least a fiberglass layer is recessed a predetermined first distance from the at least an edge of the PET foam core and a second fiberglass layer disposed onto the first fiberglass layer is recessed a predetermined second distance from an edge of the first fiberglass layer.

The advantage of the present invention is that it provides a SIP that is substantially impervious to water, insect infestation, and decay.

A further advantage of the present invention is that it provides a SIP and construction method associated therewith that provides improved thermal insulation by substantially preventing thermal breaks between adjacent panels.

A further advantage of the present invention is to provide a SIP and construction method associated therewith that increases the strength of a building for resisting higher windspeeds.

A further advantage of the present invention is to provide a SIP using PET foam made from recycled waste PET material.

### BRIEF DESCRIPTION OF THE DRAWINGS

A preferred embodiment of the present invention is described below with reference to the accompanying drawings, in which:

FIGS. 1a to 1c are simplified block diagrams illustrating a top view and side views, respectively, of a SIP according to a preferred embodiment of the invention;

FIGS. 1d and 1e are simplified block diagrams illustrating top views of fiberglass layers of the SIP according to the preferred embodiment of the invention;

FIG. 1f is a simplified block diagram illustrating a side view of a joint of two SIPs according to the preferred embodiment of the invention;

FIG. 1g is a simplified block diagram illustrating a side view of a corner joint of two SIPs according to the preferred embodiment of the invention;

FIGS. 1h and 1i are simplified block diagrams illustrating a top view and a bottom view, respectively, of a SIP used in the corner joint of two SIPs according to the preferred embodiment of the invention;

FIG. 2 is a simplified block diagram illustrating a cross sectional view of the SIP mounted to a foundation according to the preferred embodiment of the invention;

FIGS. 3a to 3c are simplified block diagrams illustrating cross sectional views of a structural element according to the preferred embodiment of the invention;

FIG. 3d is a simplified block diagram illustrating a side view of a structural element according to the preferred embodiment of the invention;

FIG. 4 is a simplified block diagram illustrating a cross sectional view of a finished ceiling of a building constructed using the SIP according to the preferred embodiment of the invention;

FIG. 5 is a simplified block diagram illustrating a side view of a design of a building wall using the SIP according to the preferred embodiment of the invention; and,

FIGS. 6a and 6b are simplified block diagrams illustrating a cross sectional view and a top view of the according to the preferred embodiment of the invention with the SIP being adapted for receiving a skylight.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a residential building, it will become evident to those skilled in the art that the embodiments of the invention are not limited thereto, but are also adaptable for various other applications such as, for example, other types of buildings, in-ground swimming pools, boats, trailers, and refrigeration panels.

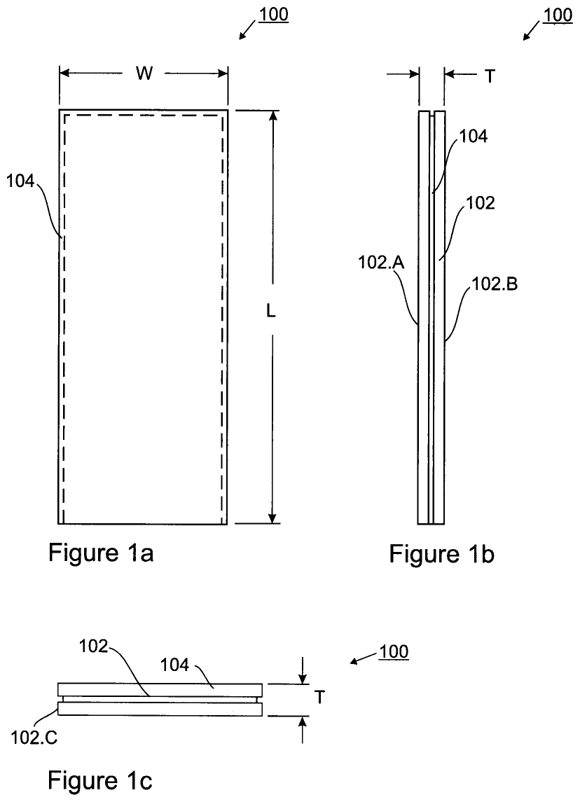

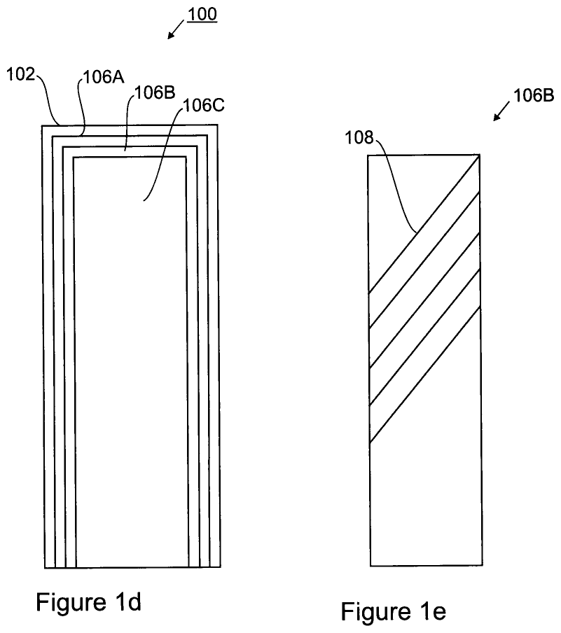

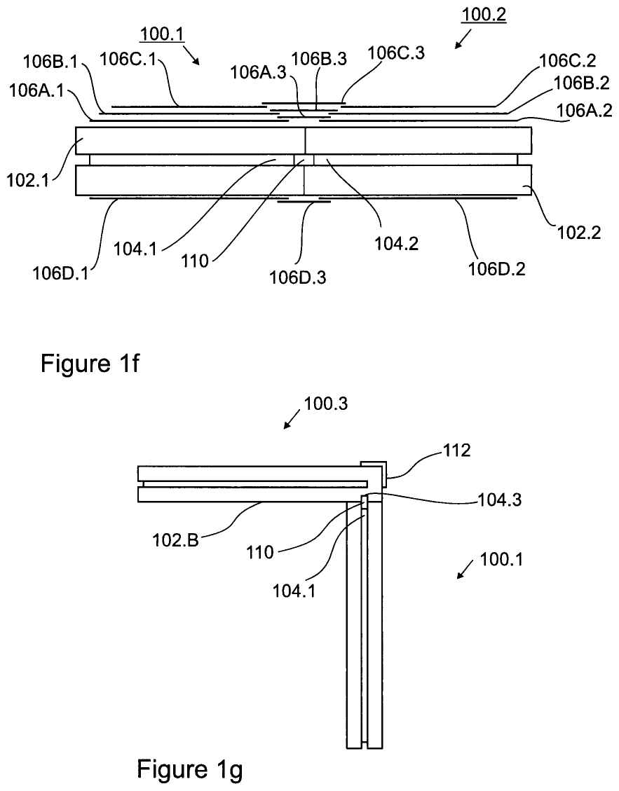

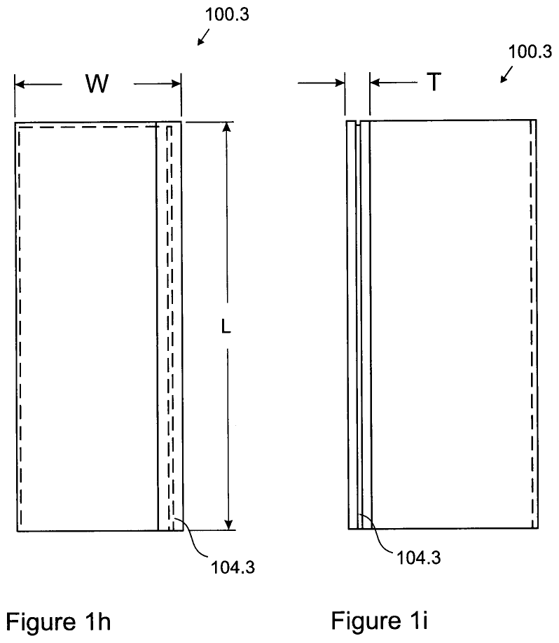

Referring to FIGS. 1a to 1i a SIP 100 and a construction method associated therewith according to a preferred embodiment of the invention is provided. The SIP 100 comprises a substantially flat PET foam core 102 having a predetermined length L, width W, and thickness T. The PET foam core 102 is, for example, manufactured to predetermined size or may be cut—using, for example, a suitable saw—a desired shape and size. Grooves 104 are disposed in the PET foam core 102 in predetermined locations depending on the location in the house, i.e. location of adjacent SIPs 100, as will be described hereinbelow. For example, the grooves 104 are disposed in three side surfaces 102.0 of the PET foam core 102, as illustrated in FIGS. 1a to 1c. The grooves 104 are disposed using, for example, a conventional router, having a predetermined width and depth, for example, 1″ by 1″. The SIP 100 further comprises at least a conventional fiberglass layer disposed on each of a first surface 102.A and a second surface 102.B of the PET foam core 102 in a conventional manner.

In an example implementation the SIP 100 comprises: a PET foam core 102 having a thickness T of 6″; 2 layers of commercially available 2 oz Chopped Strand Matt (CSM) 106D disposed on the first surface 102.A; and 1 layer of commercially available 2 oz CSM 106A, 1 layer of commercially available 2408 Biax 45 degrees 106B (with strands 108 oriented at an angle of 45°, as illustrated in FIG. 1e), and 1 layer of commercially available 2 oz CSM 106C. Preferably, the double layer 106D and the fiberglass layer 106A are recessed a predetermined distance—for example, 2″—from the edge of the PET foam core 102 where the grooves 104 for joining with adjacent panels are disposed. The fiberglass layers 106B and 106C are then also recessed from the respective previous layer the predetermined distance as illustrated in FIG. 1d.

Preferably, the SIP 100 is produced using the following process. After cutting and routering, the PET foam core 102 is cleaned using, for example, a vacuum. Commercially available general-purpose polyester resin (mixed with a suitable catalyst) is disposed onto the first surface 102.A of the PET foam core 102 and distributed equally over the entire surface area. After curing, the same process is repeated for the second surface 102.2. After curing, the polyester resin is disposed onto the first surface 102.A together with the 2 layers of 2 oz CSM 106D with the fiberglass layers being immersed into the resin using a roller. After curing, the polyester resin is disposed onto the second surface 102.B together with the 1 layer 2oz CSM 106A, 1 layer 2408 Biax 106B, and the 1 layer 2 oz CSM 106C with the fiberglass layers being immersed into the resin using a roller.

In the example implementation the fiberglass laminates and the combinations thereof were chosen to substantially maximize weight strength ratios. On the compression side of the SIPs 100—outside facing surface of the SIPs 100 experiencing direct wind loads—are the 2 layers of 2 oz CSM 106D. On the tension side of the SIPS—inside facing surface of the SIPs—the layers are chosen to be stronger by combining the 1 layer 2 oz CSM 106A, 1 layer 2408 Biax 106B, and the 1 layer 2 oz CSM 106C.

It is noted that the above is an example implementation and the invention is not limited thereto. Various thicknesses T of the PET foam core 102, as well as various other materials, combinations thereof, and number of layers may be employed depending on the design of the building and the desired strength. For example, other materials may include 1-½ oz CSM, 2408 Biax 0-90 degrees, 3408 Triax, and 24 oz Woven Roving.

The combination of PET foam core and resin immersed fiberglass layers of the SIP 100 renders the same impervious to water, insect infestation, and decay.

Optionally, commercially available Hetron resin may be employed in concert with Intumescent Gel-coat for fire-proofing the building. Alternatively, a layer of aluminum may be disposed onto the inside facing surface of the SIP 100.

Further optionally, the polyester resin may be replaced with an ISO Resin or a Vinyl Ester resin when the SIP 100 is to be exposed to extreme cold.

Further optionally, the SIP 100 may be provided in various other shapes than a flat panel such as, for example, various curved shapes, depending on architectural design preferences.

Adjacent SIPs 100.1 and 100.2 are connected such that the groove 104.1 of the SIP 100.1 faces the respective groove 104.2 of the SIP 100.2, as illustrated in FIG. 1f. Joining element 110 having a cross section corresponding to a cross section of the combined grooves 104.1 and 104.2 and extending the complete length thereof is disposed therein during assembly to substantially prevent thermal break. Preferably, the joining element 110 is made of the same PET foam material as the PET foam cores 102.1 and 102.2 and dimensioned to be accommodated in the combined grooves 104.1 and 104.2 in a snug fit. It has been found that using the same material for the PET foam cores 102.1 and 102.2 and the joining element 110 substantially prevents thermal breaks between adjacent SIPs.

Preferably, adjacent SIPs 100 are secured using the following method. After assembly of the SIPs 100, seaming strips of the same fiberglass materials as the fiberglass materials of the SIPs 100 and same resin are employed for bridging adjacent SIPs 100.1 and 100.2, as illustrated in FIG. 1f. In the example implementation, as described above with 2″ recesses, a 6″ wide seaming strip 106A.3 of 2 oz CSM together with the resin is disposed bridging the PET foam cores 102.1 and 102.2 and overlapping the respective layers 106A.1 and 106A.2, followed by a 10″ wide seaming strip 106B.3 of 2408 Biax covering the seaming strip 106A.3 and overlapping the respective layers 106B.1 and 106B.2, followed by a 14″ wide seaming strip 106C.3 of 2 oz CSM covering the seaming strip 106B.3 and overlapping the respective layers 106C.1 and 106C.2. On the opposite side two 6″ wide seaming strips 106D.3 of 2 oz CSM together with the resin are disposed bridging the PET foam cores 102.1 and 102.2 and overlapping the respective layers 106D.1 and 106D.2. This method, together with the joining elements 110, obviate the need for disposing adhesive between adjacent SIPs, thus substantially reducing the likelihood of thermal breaks between adjacent SIPs. Optionally, after curing the surface of the joining area may be faired to provide a smoother surface, for example, if the assembled SIPs 100 remain exposed and are simply painted.

Referring to FIGS. 1g to 1i, a corner joint of two adjacent SIPs 100.1 and 100.3 is provided. Here, the SIP 100.3 comprises a groove 104.3 disposed in the second surface 102.B instead of the side surface 102.C. Assembly of the adjacent SIPs 100.1 and 100.3 is the same as described hereinabove with the joining element 110 disposed in the grooves 104.1 and 104.3 and seaming strips applied inside and outside. Preferably, a prefabricated fiberglass corner element 112 is disposed onto the outside end of the SIP 100.3 covering the outside edge, thus obviating fairing and applying of fiberglass layers around the corner edge. The fiberglass corner element 112 is adhered to the SIP 100.3 using, for example, a commercially available methacrylate adhesive such as Plexus or Weld-on. Preferably, the fiberglass corner element 112 is mounted covering the edges of the fiberglass layers disposed onto the outside of SIP 100.3 and the seaming strips disposed on the joint between the SIP 100.1 and 100.3, thus providing an aesthetically pleasing corner as well as adding strength.

The fiberglass corner element 112 is manufactured using, for example, stainless steel tubing having a square or rectangular cross section and rounded corners. The surface of the metal tubing is waxed to prevent adherence of the fiberglass material thereto. After waxing, resin and a plurality of layers of, for example, 2 oz CSM are disposed onto two adjacent outside surfaces and around one corner of the waxed metal tubing. After curing, the fiberglass corner element 112 is removed from the tubing and surplus is removed by cutting and fairing.

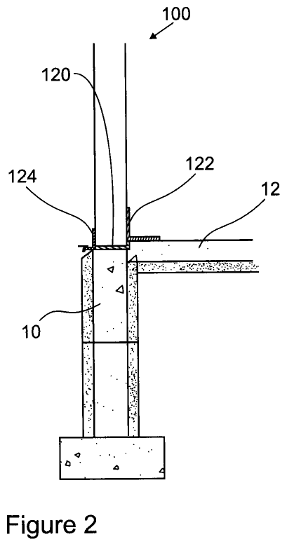

Referring to FIG. 2, a preferred method of mounting the SIPs 100 to a concrete foundation 10 and concrete floor 12 according to the invention is provided. The SIPs 100 are mounted to the concrete foundation 10 using a commercially available epoxy adhesive 120 disposed therebetween. An L-shaped epoxy seaming 122—using a commercially available epoxy such as, for example, East System super bond marine epoxy—is then disposed onto the inside of the SIP 100 and the concrete floor 12 extending a predetermined distance on the SIPs 100 and the concrete floor 12 for providing a substantially strong bond between the SIPs 100 and the concrete floor 12, thus enabling the building to withstand substantially large wind loads. Conventional drip edge 124 is mounted to the outside of the SIPs 100 covering the joint between the SIPs 100 and the concrete foundation 10.

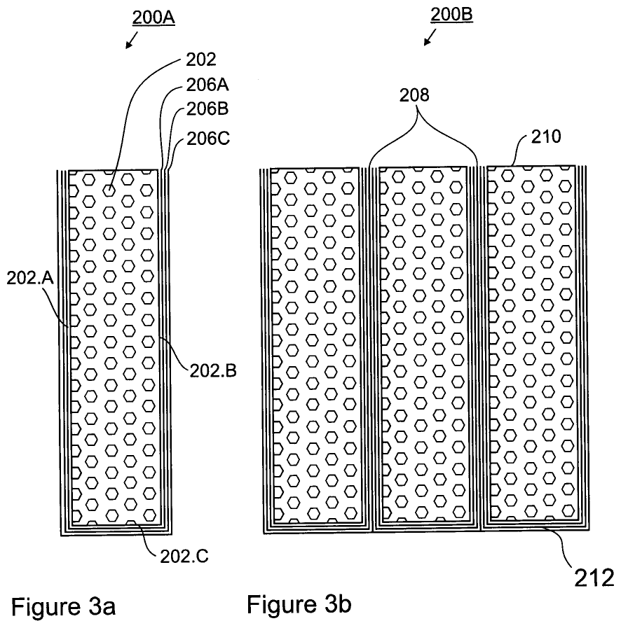

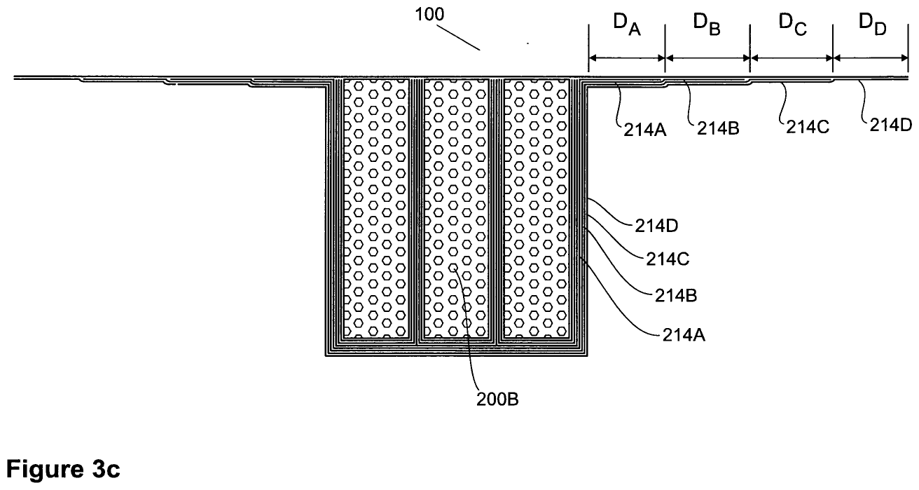

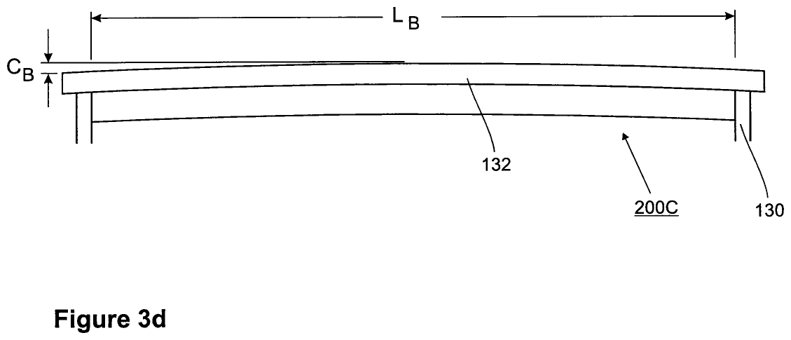

Referring to FIGS. 3a to 3d, structural elements 200A, 200B, and 200C according to a preferred embodiment of the invention are provided. The structural element 200A comprises an elongated substantially flat PET foam core 202 having a predetermined length, width, and thickness and at least a fiberglass layer 206A, 206B, 206C disposed at least on each of first surface 202.A, second surface 202.B and surface 202.0 of the PET foam core 202.

In the example implementation described hereinabove the PET foam core 202 has a length of approximately 15′, a width of 8″, and a thickness of 2″. The fiberglass layers are 1 layer of 2 oz CSM 206A, 1 layer of 2408 Biax 45 degrees 206B, and 1 layer of 2 oz CSM 206C and are disposed onto the PET foam core 202 in a same fashion as described hereinabove.

A plurality of structural elements 200A are combined, for example, three elements, as illustrated in FIG. 3b, to form structural element 200B using an adhesive 208 such as, for example, commercially available adhesive Divilette.

Preferably, the structural element 200B is connected to SIPs 100, for example, forming a roof 132 of the building, using at least a connecting fiberglass layer 214A, 214B, 214C, 214D disposed onto the structural element 200B surrounding the same and onto a predetermined surface area of the SIPs 100. Further preferably, the connecting fiberglass layers are disposed such that successive fiberglass layers extend beyond the respective previous layer a predetermined distance D_{A}, D_{B}, D_{C}, and D_{D} and are adhered to the SIP 100.

In the example implementation described hereinabove the connecting fiberglass layers are 1 layer of 2 oz CSM 214A, 2 layers of 2408 Biax 45 degrees 214B and 214C, and 1 layer of 2 oz CSM 214D and are disposed in a same fashion as described hereinabove with each of the predetermined distances D_{A}, D_{B}, D_{C}, and D_{D} being 2″.

The ends of the structural element 200B are connected to SIPs 100 forming a wall 130, for example, by accommodating an end portion thereof in recesses disposed at respective locations in the SIPs 100 and joining the same using seaming strips.

It is noted that the above is an example implementation and the invention is not limited thereto. Various sizes of the Pet foam core 202, as well as various other materials, combinations thereof, and number of layers may be employed depending on the design of the building and the desired strength. For example, other materials may include 1-½ oz CSM, 2408 Biax 0-90 degrees, 3408 Triax, and 24 oz Woven Roving. Furthermore, the structural elements 200A may be employed as beams in various manners such as, for example, as single elements 200A or as combinations of two, three or more to form structural elements 200B.

It is noted that the elements 200A and 2008 may also be adapted to form posts, cantilevers, and braces.

The structural element 200C illustrated in FIG. 3d is “pre-stressed” by slightly bending the PET foam core 202—for example, a curvature C_{B} of 2″ over a length L_{B} of 15′—prior disposing of the fiberglass layers thereon.

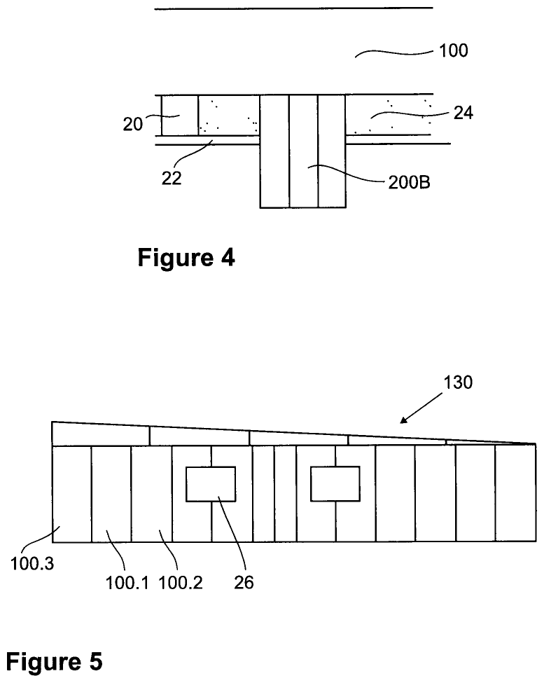

The inside of the building is finished, for example, using conventional strapping 20 and gypsum board or drywall 22 to the SIPs 100, for example, forming a ceiling as illustrated in FIG. 4. The strapping 20 and the gypsum board 22 are mounted in a conventional manner using, for example, screw fasteners. Optionally, acoustic barrier material 24 is disposed between the gypsum board 22 and the SIPs 100. While FIG. 4 illustrates a ceiling, the walls of the building may be finished in a similar manner with wiring and plumbing being disposed in the space between the gypsum board and the SIPs. It is noted that the wiring and the plumbing may be secured to the SIPs in a conventional manner using, for example, screw fasteners.

Shape and size of each of the SIPs 100, as well as the location of grooves 104 and the recesses of the fiberglass layers are determined during design of the building, as illustrated for a wall 130 in FIG. 5, using, for example, a commercially available CAD software program executed on a computer.

For example, the panels are determined to provide openings 26 for installing windows or alternatively, the opening are cut out from the SIPs after assembly thereof.

It is noted that the windows are installed in the SIPs 100 similar to the installation in conventional SIPs.

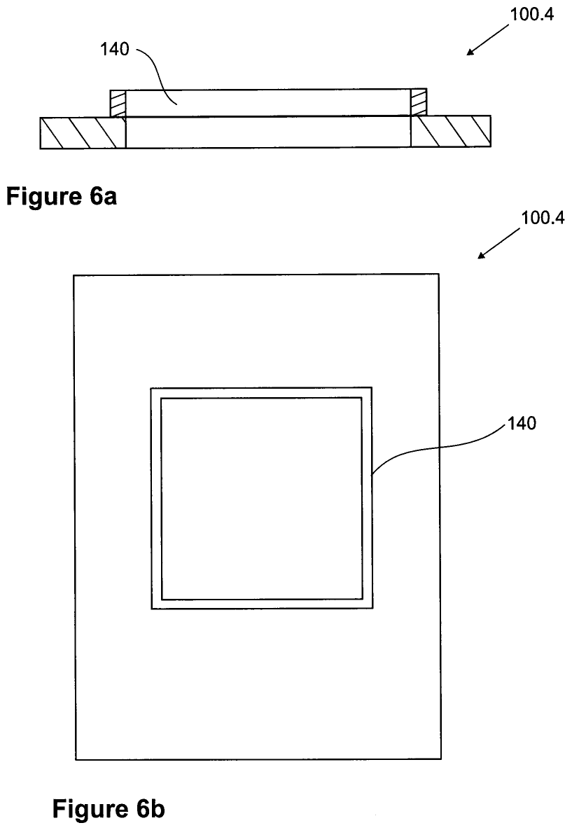

Referring to FIGS. 6a and 6b, a SIP 100.4 comprises an opening and a flange 140 for installation of a skylight. The flange 140 is made of PET foam and mounted to the SIP using adhesive. After mounting, fiberglass layers are disposed onto the SIP and the flange 140 bridging the flange 140 and the SIP for providing a waterproof seal. After assembly, the skylight is installed, for example, by: disposing an adhesive gel onto the flange 140; placing a recess disposed in the frame of the skylight onto the frame 140; and securing the skylight frame to the flange 140 using conventional screw fasteners.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A structural insulated panel comprising:
a substantially flat PET foam core having a predetermined length, width, and thickness;
at least a fiberglass layer disposed on each of a first and a second surface of the PET foam core; and,
at least a groove disposed in the PET foam core, the at least a groove being disposed in proximity to an edge of the PET foam core and being adapted for accommodating a joining element therein.

2. The structural insulated panel according to claim 1 wherein the at least a fiberglass layer is recessed a predetermined distance from the edge of the PET foam core.

3. The structural insulated panel according to claim 1 wherein the at least a fiberglass layer is adhered to the PET foam core using a polyester resin.

4. The structural insulated panel according to claim 1 wherein the at least a fiberglass layer comprises at least one of chop strand matt and a biaxial laminate.

5. The structural insulated panel according to claim 2 wherein a first fiberglass layer of the at least a fiberglass layer is recessed a predetermined first distance from the edge of the PET foam core and wherein a second fiberglass layer disposed onto the first fiberglass layer is recessed a predetermined second distance from an edge of the first fiberglass layer.

6. The structural insulated panel according to claim 1 wherein the structural insulated panel is connected to a respective second structural insulated panel such that the groove of the structural insulated panel faces a respective groove of the second structural insulated panel and wherein the joining element is disposed in the grooves of the structural insulated panel and the second structural insulated panel.

7. The structural insulated panel according to claim 6 wherein the joining element is made of PET foam.

8. The structural insulated panel according to claim 7 wherein the at least a fiberglass layer of each of the structural insulated panel and the second structural insulated panel is recessed a predetermined distance from the edge of the PET foam core and wherein a seaming fiberglass strip is disposed on the surface areas of the structural insulated panel and the second structural insulated panel between the respective PET foam edge and the recessed fiberglass layer.

9. The structural insulated panel according to claim 8 wherein the seaming fiberglass strip is adhered to the structural insulated panel and the second structural insulated panel using a polyester resin.

10. The structural insulated panel according to claim 1 wherein the structural insulated panel is connected to a concrete foundation using an epoxy adhesive disposed between the structural insulated panel and the respective surface area of the concrete foundation.

11. The structural insulated panel according to claim 10 wherein an L-shaped epoxy seaming is disposed onto the structural insulated panel and a concrete floor.

12. The structural insulated panel according to claim 6 wherein the structural insulated panel and the second structural insulated panel form a corner and wherein a fiberglass corner element is disposed onto one of the structural insulated panel and the second structural insulated panel such that an outside edge thereof is covered.

13. The structural insulated panel according to claim 1 wherein the PET foam core is made of 100% recycled PET.

14. A structural element comprising:
an elongated substantially flat PET foam core having a predetermined length, width, and thickness; and,
at least a fiberglass layer disposed at least on each of a first and a second surface of the PET foam core and a surface connecting the same.

15. The structural element according to claim 14 wherein the structural element is connected to a respective second structural element using an adhesive disposed between a second surface of the structural element facing a respective first surface of the second structural element.

16. The structural element according to claim 15 wherein the structural element and the second structural element are connected to a structural insulated panel according to claim 1 using at least a connecting fiberglass layer disposed onto the structural element and the second structural element surrounding the same and onto a predetermined surface area of the structural insulated panel.

17. The structural element according to claim 16 wherein a second fiberglass layer of the at least a connecting fiberglass layer is extending a first fiberglass layer and is disposed onto the predetermined surface area of the structural insulated panel.

18. The structural element according to claim 14 wherein the PET foam core is slightly curved.

19. A structural insulated panel comprising:
a substantially flat PET foam core having a predetermined length, width, and thickness; and, at least a fiberglass layer disposed on each of a first and a second surface of the PET foam core such that the at least a fiberglass layer is recessed a predetermined distance from at least an edge of the PET foam core.

20. The structural insulated panel according to claim 19 wherein a first fiberglass layer of the at least a fiberglass layer is recessed a predetermined first distance from the at least an edge of the PET foam core and wherein a second fiberglass layer disposed onto the first fiberglass layer is recessed a predetermined second distance from an edge of the first fiberglass layer.
